(19) United States
(12) Patent Application Publication
(10) Pub. No.: US 2025/0344135 A1
(43) Pub. Date: Nov. 6, 2025

(54) System Information Indicating a Type Parameter Associated with a Group Identity

(71) Applicant: Telefonaktiebolaget LM Ericsson (publ), Stockholm (SE)

(72) Inventors: Christofer Lindheimer, Vadstena (SE); Mai-Anh Phan, Herzogenrath (DE); Oscar Ohlsson, Bromma (SE); Hernán Felipe Arraño Scharager, Täby (SE); Miguel Angel Garcia Martin, Madrid (ES); Peter Hedman, Helsingborg (SE)

(21) Appl. No.: 18/284,454

(22) PCT Filed: Mar. 29, 2022
(86) PCT No.: PCT/SE22/50309

§ 371 Date: Sep. 27, 2023

(51) Int. Cl. H04W 48/12; H04W 48/16

(52) U.S. Cl. CPC H04W 48/12; H04W 48/16

(57) ABSTRACT

Embodiments herein relate to, for example, a method performed by a radio network node for handling communication in a wireless communications network, wherein the radio network node is preconfigured with group identities and/or type parameters. The radio network node transmits system information with a type parameter associated with a group identity, GID, wherein the type parameter indicates a type of service offered by one or more networks identified by the GID.

### TECHNICAL FIELD

Embodiments herein relate to a radio network node, a user equipment (UE) and methods performed therein regarding wireless communication. Furthermore, a computer program product and a computer-readable storage medium are also provided herein. In particular, embodiments herein relate to handling communication, such as handling or controlling access to a radio network node, e.g., a non-public network for a service, in a wireless communications network.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and present and coming 3GPP releases, such as New Radio (NR) and extensions, are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

3GPP is currently working on Release 17 enhancements to first specifications of the 5G system of Release (Rel) 15 and/or 16. These types of enhancements are made to functionality that was introduced in early releases of the 5G specification.

One such functionality is Non-Public Networks, also known as NPNs, that was introduced in Release 16.

3GPP introduced support for two non-public networks deployment options from Release 16.

The first NPN option outlines how operators could support non-public networks or dedicated deployments by associating them directly to the operator network. Such improvements resulted in solutions for what is commonly referred to as Public Network Integrated NPN (PNI-NPN).

The second NPN option is the stand-alone NPN, or SNPN for short. In almost all aspects, this is a network that carries the same functionality and characteristics as the more commonly known Public Land Mobile Network (PLMN), but it differs in some aspects, e.g., an SNPN is identified by an SNPN identifier (ID) rather than a PLMN ID. The SNPN ID is composed of a PLMN ID and a Network ID (NID). Additionally, there is no support for mobility between SNPNs, in the same way as is possible between, equivalent, PLMNs.

In a cell, herein understood as an entity that sends a broadcast, e.g., system information block one (SIB1) message, there can be one or many NPNs or PLMNs sharing the resources, e.g., frequency and processing capabilities, and such situations are commonly referred to as RAN sharing.

One and the same System Information Block (SIB) broadcast can thus represent different networks and for each of these, there can be specific identifiers such as Cell IDs, i.e., different “logical” cells, and different Tracking Area Codes (TAC).

To account also for sharing between PLMNs and NPNs, between PLMNs only or between NPNs only, two different lists have been defined in the broadcast, one for listing NPNs, comprising both SNPNs and PNI-NPNs, referred to as npn-IdentityInfoList and one for listing PLMNs, referred to as plmn-IdentityList, see below.

These lists are defined in 3GPP TS 38.331 [2] and are broadcast in SIB1.

```
  -- ASN1START
  -- TAG-CELLACCESSRELATEDINFO-START
```

| CellAccessRelatedInfo ::= | SEQUENCE { | |
|---|---|---|
| plmn-IdentityList | PLMN-IdentityInfoList, | |
| cellReservedForOtherUse | ENUMERATED {true} | OPTIONAL, -- Need |

```
R
    ...,
    [[
```

| | | |
|---|---|---|
| cellReservedForFutureUse-r16 | ENUMERATED {true} | OPTIONAL, -- |

Need R

| | |
|---|---|
| npn-IdentityInfoList-r16 | OPTIONAL -- Need R |

```
    ]]
  }
  -- TAG-CELLACCESSRELATEDINFO-STOP
  -- ASN1STOP
```

The different lists allow an operator, PLMN-specific or, e.g., neutral host operator, to support a number of different PLMNs and NPNs in the broadcast. Abstract Syntax Notation (ASN; ASN1; ASN.1) used herein, e.g. as code snippets, describes what information is/may be communicated in each referenced scenario.

### SNPN Encoding

The following is specified in 3GPP Technical Specification (TS) 23.501 [3], clause 5.30.2.1:

The combination of a PLMN ID and Network identifier (NID) identifies an SNPN.

NOTE 1: The PLMN ID used for SNPNs is not required to be unique. PLMN IDs reserved for use by private networks can be used for non-public networks, e.g. based on mobile country code (MCC) 999 as assigned by ITU [78]). Alternatively, a PLMN operator can use its own PLMN IDs for SNPN(s) along with NID(s), but registration in a PLMN and mobility between a PLMN and an SNPN are not supported using an SNPN subscription given that the SNPNs are not relying on network functions provided by the PLMN.

The NID shall support two assignment models:
Self-assignment: NIDs are chosen individually by SNPNs at deployment time (and may therefore not be unique) but use a different numbering space than the coordinated assignment NIDs as defined in TS 23.003 [19].
Coordinated assignment: NIDs are assigned using one of the following two options:
1. The NID is assigned such that it is globally unique independent of the PLMN ID used; or
2. The NID is assigned such that the combination of the NID and the PLMN ID is globally unique.

NOTE 2: Which legal entities manage the number space is beyond the scope of this specification.

FIG. 1a illustrates a standard method of structuring the Network ID when assignment mode 0 is used, according to 3GPP TS 23.003 [6]. The NID consists of 44 bits, and it is structured into:
4 bits (one hexadecimal digit) indicating the assignment mode, in this case, this structure refers to the assignment mode 0, which indicates the structure of the NID in the subsequent fields.
32 bits indicating the Private Enterprise Number (PEN) of the network. PEN is globally unique 32-bit non-negative integer that identifies a private enterprise. The PEN is assigned by Internet Assigned Numbers Authority (IANA). According to 3GPP, the PEN represents the service provider of the SNPN.
8 bits indicating the NID Code. According to 3GPP, the NID Code identifies the SNPN within the service provider identified by the NID PEN.

For NPN, the enhancements currently addressed are described in 3GPP Technical Report (TR) 23.700-07 [1], which outlines a number of key issues, which can be translated into enhancement areas.

Access to an SNPN using credentials in a separate entity (Key issue #1).

Key issue #1 describes a situation when a UE can access an SNPN using credentials not from the SNPN itself, but from another, separate entity (3rd party), which can be another Service Provider (SP), or Subscription Provider.

The challenges related to KI #1 are described in TR 23.700-07 [1] as:

“This key issue aims at addressing the following points for SNPN along with subscription owned by an entity separate from the SN PN:
How to identify the separate entity providing the subscription.
Network selection enhancements, including UEs with multiple subscriptions;
E.g. how does the UE discover and select an SNPN which provides authentication in an external entity;
Architecture enhancements needed to support multiple separate entities, e.g.:
What are the interfaces exposed and/or used by SNPN and the separate entity;
What is the architecture and solution for a UE accessing a separate entity via SNPN access network;
How to exchange authentication signalling between the SNPN and the separate entity, including:
Authentication by the PLMN, based on PLMN identities and credentials, for access to the SNPN;
Authentication via SNPN to separate entity based on non-3GPP identities (e.g. non-International Mobile Subscriber Identity (IMSI)) and credentials;
Mobility scenarios, including service continuity, for:
UE moving from SNPN #1 with separate entity #1 to SNPN #2 with separate entity #1 available; and
UE moving between SNPN #1 (where separate entity=PLMN) and PLMN.

NOTE: Security aspects should be defined by SA WG3.”

3GPP TR 23.700-07 [1] indicates the following relevant conclusions for KI #1:
Group ID as a specific case of SNPN ID reusing SNPN ID encoding in TS 23.003, where
SIB will be enhanced as follows, for SNPN only:
Indication that “access using credentials from a separate entity is supported”
Optionally, supported Group IDs (GID)
Optionally, an indication whether the SNPN allows registration attempts from UEs that are not explicitly configured to select the SNPN

In the following, we explain the above conclusions for KI #1.

In order for a UE to discover and select an SNPN which provides authentication in an external entity, i.e., the service/subscriber provider (SP), TR 23.700-07 [1] concludes that SNPNs need to indicate these new functionalities to UEs. Otherwise, the UEs would not know that they can access these networks with the credentials they possess from the SP.

Furthermore, it was also concluded to allow an SNPN to indicate whether it allows registration attempts from UEs that are not explicitly configured to select this SNPN, hence enabling UEs to perform blind registration attempts, which eventually, may fail if the SNPN does not have means to authenticate the UE.

Detailed explanation on the Group ID (GID).

Finally, it was concluded to introduce a Group ID, herein referred to as GID, which provides the aggrupation of one or more SPs, to constitute an easy association between (the group of) SPs and SNPNs as illustrated in FIG. 1b.

FIG. 1b shows association between SNPN and, group of, SPs the latter being identified by a GID.

The GID is mainly intended for the UE in network selection procedure and should associate the UE credentials from the SP with various SNPNs that support access using such credentials. At a later stage, 3GPP referred to this GID as “Group ID for network selection”, or GIN for short to be more specific what this GID is used for. In addition, the SP is also referred to as “Credentials Holder (CH)”.

In this sense, and in specific cases where an SNPN does not hinder registration attempts from UEs that are not explicitly configured to select the network, the use of GIDs could also reduce the number of opportunistic registration attempts. The thinking behind the GID or GIN is that it would be easier to handle changing support for access of a certain SP, or that it would be easier also for SNPNs to advertise what SPs are supported, especially in scenarios in which the number of these is large. Thus, the GID is bridging the association between SNPNs and service providers in a many-to-many possible relationship that can change without the need to change the UE configuration which would list all the SNPNs supporting access using credentials from any of the SPs identified by the GID.

In summary, the GID for Network selection (GIN) is an identifier of a collection of Subscription Providers (SP).

The use of GIDs is exemplified in 3GPP TR 23.700 07 [1] as follows:

“Home SP Group examples include:
National operating companies of a multi-national operator
By broadcasting the Home SP Group ID assigned to the multi-national operator, a visiting (V)-SNPN can enable the UEs from all the national operating companies of the multi-national operator to select the V-SNPN (instead of having to broadcast the Home SP IDs of each of the national operating companies, which may also exceed the number of Home SP IDs supported by SIB).
Home SPs that are connected to an interconnection provider
Typically mobile operators have direct interconnections and agreements only with large partner networks.
For the large amount of small partner networks, mobile operators typically use the services of an interconnection provider that provides interconnection with a large amount of partner networks while avoiding the need for bilateral agreements and interconnections.
By broadcasting the Home SP Group ID assigned to the interconnection provider, a V-SNPN can enable the UEs from all the Home SPs connected to the interconnection provider to select the V-SNPN (instead of having to broadcast the IDs of each of the Home SPs, which may also exceed the number of Home SP IDs supported by SIB) while also avoiding the need for the Home SPs to maintain an accurate list of all the supported V-SNPNs.

NOTE 1: The Home SP Group ID is assumed to be globally unique or self-managed. Assignment of a unique Home SP Group ID is beyond the scope of 3GPP.

The “Home SP” used in the cited text above is simply referred to as SP. The V-SNPN used in the text above is the visited network from the UE's or SP's point of view. It is generally referred to as SNPN herein. The “Home SP Group ID” used above is simply referred to as GID.

As described in 3GPP TR 23.700-07 [1], clause 8.1.4, the UE is pre-configured with the parameters below which assist the UE in the network selection:

“
UE configuration:
User-controlled prioritized list of preferred SNPNs.
Separate entity controlled prioritized list of preferred SNPNs.
Separate entity-controlled prioritized list of Group IDs (GIDs).

NOTE 3: The UE may also only be configured with the separate entity-controlled prioritized list of preferred SNPNs or only the separate entity-controlled prioritized list of Group IDs.

”

The pre-configuration is performed by the CN on the Non-Access Stratum (NAS) layer, e.g., by the service provider and/or credentials holder of the UE. The configuration may at any time be updated by the CN.

As described in 3GPP TR 23.700-07 [1], clause 6.2.2.3, the Home SP Group IDs, i.e., the GIDs, are broadcast per SNPN:

“NG-RAN nodes which support access using Home SP credentials broadcast the following information per SNPN: [ . . . ] List of supported Home SP Group IDs”

As mentioned above, the GID may identify one or multiple SPs and is used for network selection.

UE behavior for GID usage.

In the 3GPP TR 23.700-07 [1], the following UE behavior is captured:
UE selects an available and allowable SNPN which broadcasts “access using credentials from a separate entity is supported” indication and a GID contained in the separate entity-controlled list (if available).

In other words, a UE that is equipped with credentials from a service provider that can be used to access certain SNPNs, is thus also configured with a GID. When the UE is moving around, and performing network selection, it can scan and detect available networks. The UE then detects SNPN ID(s) and GID(s) broadcast by the SNPN.

The UE decodes the available networks IDs in the cell from the npn-IdentityInfoLists and it also detects any list with GIDs and its association to these networks.

Now, the UE may select an SNPN that provides authentication to an SP that is part of the GID, by comparing the GIDs it is configured with, with the GIDs broadcast by the SNPN.

The UE network selection procedure would then select one of the SNPNs it is allowed to access, given the credentials and the GIDs the UE is configured with.

Manual network selection.

In the TR, the following is captured for manual selection:
For manual SNPN selection the UE presents all available SNPNs, which broadcast the “access using credentials from a separate entity is supported” indication.

It has also been proposed in 3GPP to broadcast a human readable name for the GIDs similar to the Human Readable Network Name (HRNN) used for NPNs. The human readable name for the GID, herein referred to as a Human Readable Group Name (HRGN), would be displayed to the user during the manual network selection so that the user can identify the group of SPs associated with an SNPN.

UE onboarding (Key issue #4)

3GPP TR 23.700-07 [1] also discussed another key issue, labelled KI #4:

Architecture and solutions to support UE onboarding and provisioning for the NPN. This key issue includes some common aspects such as:
Means for a UE, that is verifiably secure and uniquely identifiable to 5GS, for onboarding and remote provisioning;
Support of exposure via APIs to support UE onboarding and remote provisioning, if required.
How does the UE discover and select the onboarding SNPN before UE NPN credentials and other information to enable UE to get 3GPP connectivity are provisioned.

FIG. 1c shows a UE onboarding procedure and GID addition.

During the Release 17, 3GPP SA2 working group study item phase on NPN enhancements, it was proposed that the GID can also be used to indicate a group of manufacturers, which provide UEs with default credentials. SNPNs that support onboarding using default credentials from these manufacturers, would broadcast an onboarding indication and the GID identifying these manufacturers. It should be noted that 3GPP has not yet decided which nodes the GID would identify, i.e., so far, the UE uses that GID only for SNPN selection, i.e., including selection of Onboarding (O)-SNPN.

The GID usage is included in clause 8.4.1 of the updated 3GPP TR 23.700-07 v2.0.0 [6]:

“

[ . . . ] The UE may or may not be pre-configured with O-SNPN network selection information (e.g. O-SNPN network identifiers or Group ID(s)). The O-SNPN network selection information can assist the UE such that the UE either preferably or exclusively select an O-SNPN corresponding to the O-SNPN network identifiers or Group ID(s).

NOTE 2: The format of the pre-configured information assisting the UE for O-SNPN selection is not specified.

NOTE 3: The Group ID(s) in the SIB that UE can use for selecting an O-SNPN are the same as the Group ID(s) in the SIB that the UE uses for SNPN selection as part of KI #1.

”

On comparing the problems and solutions addressed by key issues #1 and #4 from 3GPP TR 23.700-07 [1], one can notice that for accessing an SNPN using external credentials (KI #1), the UE has valid network credentials for the external entity, while for onboarding (KI #4), such network credentials still need to be provisioned to the UE as part of the UE onboarding procedure. In this sense, both key issues are highly related. However, the external entities referred to in KI #1 and in KI #4 are completely different. Nevertheless, the external entities can, in principle, be identified by the same GID that assists the UE in the network selection.

Two solutions have been proposed:
a) Introduce a GID list for KI #1, and a separate GID list of KI #4.
b) Differentiate the GID values for KI #1 and KI #4 and ensure there is no overlapping between them.

### GID Encoding

1. In 3GPP TR 23.700-07 [1] it was concluded that the GID will be encoded using the SNPN ID encoding (see Section 2.1.1 above):

The following enhancements will be progressed in the normative phase:
Group ID as a specific case of SNPN ID reusing SNPN ID encoding in TS 23.003, where
Assignment mode 1 indicates self-managed Home SP Group ID values as the NID Value is chosen independently at deployment time.
Assignment mode 0 indicates Home SP Group ID is globally unique as the NID Value is globally unique. One possibility for ensuring uniqueness is to use IANA PEN as in TS 23.003.

| | |
|---|---|
| snpn-r16 | SEQUENCE { |
| plmn-Identity-r16 | PLMN-Identity, |
| nid-List-r16 | SEQUENCE (SIZE (1..maxNPN-r16)) OF NID-r16 |

}

| | |
|---|---|
| NID-r16 ::= | BIT STRING (SIZE (44)) |

### SUMMARY

As part of developing embodiments here one or more problems were first identified. The main ambition with broadcast information is to keep it short and infrequent. Broadcasting a lot of information adds to the interference in the network and as such, directly impacts capacity that, otherwise, could be used to send user data. Since broadcast is generally always-on, and even if broadcast on-demand was configured, there are benefits in limiting the broadcast amount of data to the absolute minimum.

If an SNPN provides multiple services, e.g., authentication by a separate service provider, or onboarding of UEs, while these services are identified by the same GID, the SNPN may need to broadcast identical information more than once. In the future, more services than onboarding and SP authentication support will surface and then it is desirable to have mechanisms that can easily support signaling of such services without having to introduce completely new functionality

A related problem is that the GID as currently defined is not necessarily globally unique, e.g., if assignment mode 1 is used, which may lead to try and error attempts even if the GID in the broadcast matches the GID configured in the UE. Embodiments herein address and mitigate the above-mentioned problems. An object herein is to provide a mechanism to handle communication in an efficient manner in the wireless communications network.

According to an aspect the object is achieved, according to embodiments herein, by providing a method performed by a radio network node for handling communication in a wireless communications network. The radio network node transmits system information, wherein the system information comprises a type parameter associated with a GID indicating a type of service offered by one or more networks identified by the GID.

According to another aspect the object is achieved, according to embodiments herein, by providing a method performed by a user equipment for handling communication in a wireless communications network. The user equipment receives system information, wherein the system information comprises a type parameter associated with a GID indicating a type of service offered by one or more networks identified by the GID.

According to yet another aspect the object is achieved, according to embodiments herein, by providing a radio network node and UE configured to perform the methods, respectively.

Thus, according to still another aspect the object is achieved, according to embodiments herein, by providing a radio network node for handling communication in a wireless communications network. The radio network node is configured to transmit system information, wherein the system information comprises a type parameter associated with a GID indicating a type of service offered by one or more networks identified by the GID.

According to yet another aspect the object is achieved, according to embodiments herein, by providing a user equipment for handling communication in a wireless communications network. The user equipment is configured to receive system information, wherein the system information comprises a type parameter associated with a GID indicating a type of service offered by one or more networks identified by the GID.

It is furthermore provided herein a computer program product comprising instructions, which, when executed on at least one processor, cause the at least one processor to carry out the method above, as performed by the radio network node and UE, respectively. It is additionally provided herein a computer-readable storage medium, having stored thereon a computer program product comprising instructions which, when executed on at least one processor, cause the at least one processor to carry out the method above, as performed by the UE or radio network node, respectively.

Embodiments herein disclose a type parameter that is associated to each of for example, broadcasted GIDs. The type parameter may comprise a value that identifies the type of services offered by a group of networks identified by the GID. Examples of possible values include values indicating “provider of authentication services”, i.e., “3rd party SP” for short, and/or “provider of authentication for onboarding services”, i.e., “Onboarding” for short.

The type parameter may be represented by a separate service type indication in, for example, GID-Info.

For example, the type parameter may be represented by an indicator bitmap in which each of the bits represents a different service provided by the network. The type parameter may be represented by a list or a sequence of booleans, in which each boolean represents a different service. The type parameter may be represented by a service index which indicates one or more supported services from a pre-defined list of services. The service indexes may be pre-configured in the UE. The type parameter may be represented by an INTEGER or an index value which points to a specific service or service combination from a list of predefined services that could be provided by a network.

The type parameter may be represented by a service type indication, also referred to as GID type, encoded into the GID or GID value.

For example, the type parameter may be represented by a sequence of bits that corresponds to a codeword from a codebook of services or service combinations. A UE may need to be pre-configured with this codebook, otherwise, the UE may not know the mapping from the codeword to the service (combination). The type parameter may be implicitly provided by specific encoding of the GID. The GID encoding itself may be optimized to avoid broadcasting the PLMN ID when the remaining GID value is sufficient for non-ambiguous network selection. The type parameter may be broadcasted in SIB along with the GID to which it is associated.

The inclusion of the type parameter in SI is related to the capability of broadcasting a list of services provided by the collection of networks and service providers that integrate the GID. In the case of overlapping GID usage, the UE will know whether its service of interest, being indicated by the GID, is actually supported, and thus, trial-and-error attempts caused by GID ambiguity can be avoided. Hence, embodiments herein provide a mechanism to efficiently handle communication by providing SI comprising the type parameter associated with the GID in the wireless communications network.

### BRIEF DESCRIPTION OF THE DRAWINGS

Embodiments will now be described in more detail in relation to the enclosed drawings, in which:

FIG. 1a shows a Standard Network ID structure for assignment mode 0 according to prior art;

FIG. 1b shows an architecture according to prior art;

FIG. 1c shows an architecture according to prior art;

FIG. 2 shows a wireless communications network according to embodiments herein;

FIG. 3 shows a combined signalling scheme and flowchart according to embodiments herein;

FIG. 4 shows a flowchart depicting a method performed by a radio network node according to embodiments herein;

FIG. 5 shows a flowchart depicting a method performed by a user equipment according to embodiments herein;

FIG. 6 shows an exemplary 5G communication system comprising 5GC and NG-RAN;

FIG. 7 shows a type parameter according to embodiments herein;

FIG. 8 illustrates a type parameter according to embodiments herein;

FIG. 9 illustrates a GID;

FIG. 10 illustrates a GID according to embodiments herein;

FIG. 11a shows a schematic overview depicting a UE network selection behaviour based on GID broadcast according to embodiments herein;

FIG. 11b shows a schematic overview depicting a UE network selection behaviour based on GID broadcast according to embodiments herein;

FIG. 12 shows a block diagram depicting radio network nodes according to embodiments herein;

FIG. 13 shows a block diagram depicting UEs according to embodiments herein;

FIG. 14 schematically illustrates a telecommunication network connected via an intermediate network to a host computer;

FIG. 15 is a generalized block diagram of a host computer communicating via a base station with a user equipment over a partially wireless connection; and

FIGS. 16-19 are flowcharts illustrating methods implemented in a communication system including a host computer, a base station and a user equipment.

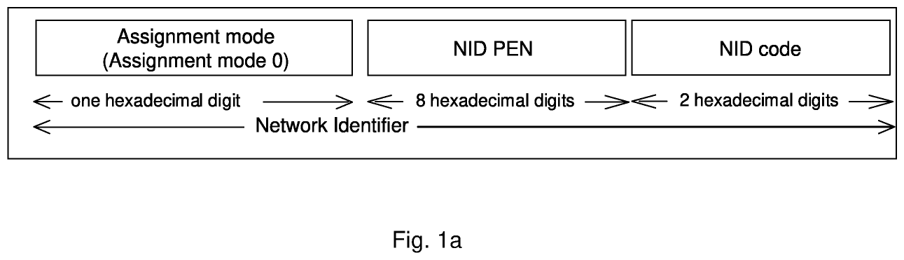

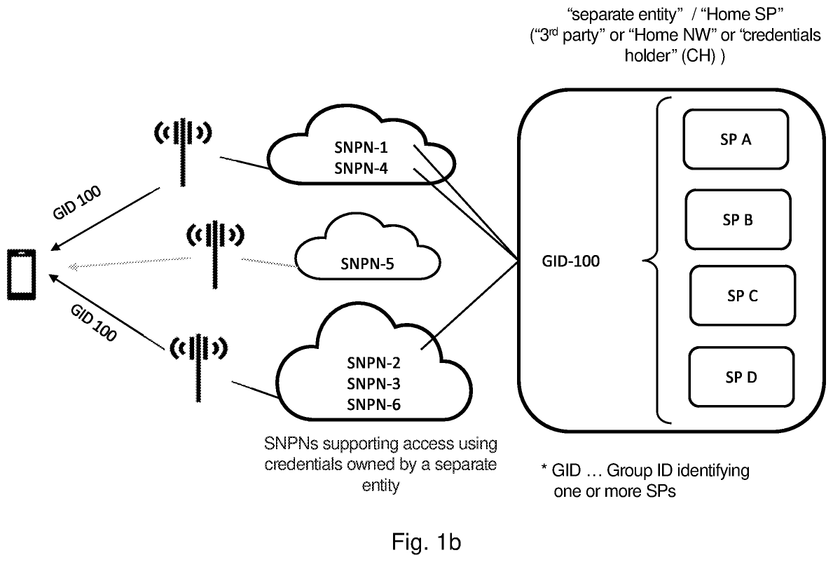

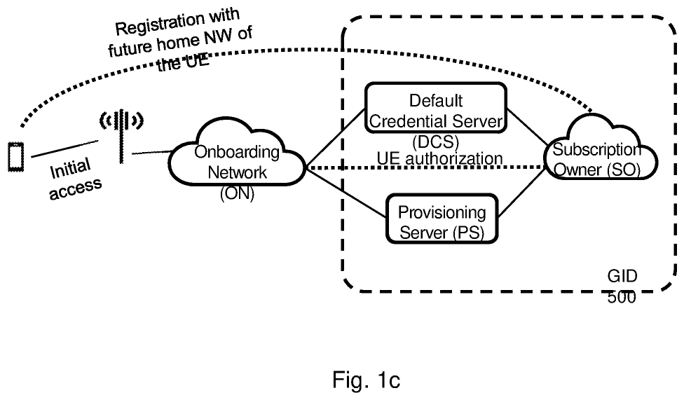

### DETAILED DESCRIPTION

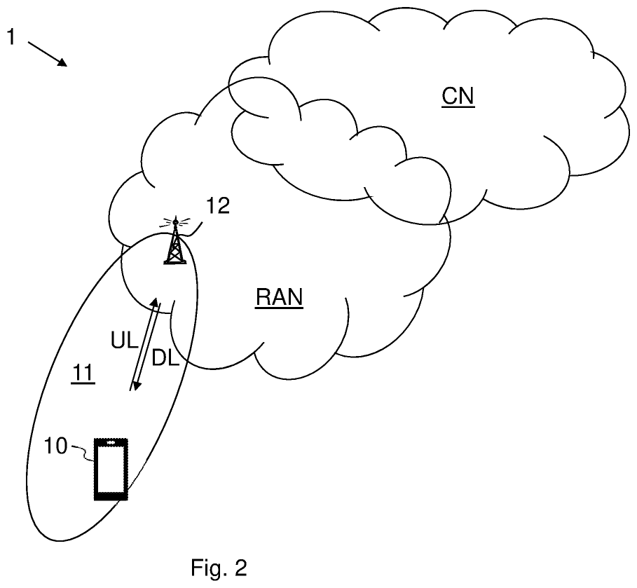

Embodiments herein relate to wireless communications networks in general. FIG. 2 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a NR context, however, embodiments are also applicable in further development of existing wireless communications systems such as e.g. LTE or WCDMA.

In the wireless communications network 1, a UE 10, exemplified herein as a wireless device such as a mobile station, a non-access point (non-AP) station (STA), a STA and/or a wireless terminal, is comprised communicating via e.g. one or more Access Networks (AN), e.g., RAN, to one or more CNs. It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a radio network node 12 providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the radio network node depending e.g. on the first radio access technology and terminology used. The radio network node may be referred to as a serving radio network node wherein the service area may be referred to as a serving cell, and the serving network node communicates with the UE 10 in form of DL transmissions to the UE 10 and UL transmissions from the UE 10. It should be noted that a service area may be denoted as cell, beam, beam group or similar to define an area of radio coverage.

In the embodiments described herein the radio network node 12 transmits, e.g., broadcasts, SI in the first cell 11. The SI comprises a type parameter associated with a GID indicating a type of service offered by one or more networks identified by the GID. GID herein identifies group of, or one or more, service providers. The type parameter may also be denoted as type indicator or type attribute. Thus, the GID may be associated with a new type parameter that identifies the different service types offered by each of the networks that integrate the group of networks identified by the GID. The GID encoding may be optimized to reduce the number of bits to be broadcast in SIB. An encoding of the type parameter may comprise the type parameter embedded into for example a NID, and that may further reduce the number of bits broadcast in the SIB.

Inclusion of the type parameter in, for example, a SIB may be related to the capability of broadcasting a list of services provided by the collection of networks and service providers that integrate the GID. In the case of overlapping GID usage, the UE 10 may know whether its service of interest, being indicated by the GID, is actually supported, and thus, trial-and-error attempts caused by GID ambiguity may be avoided.

The proposed solution enables use cases such as:
1. A manufacturer of devices, e.g., a UE manufacturer, is allocated a certain GID. The manufacturer configures the firmware of the UEs 10 to recognize such GID. Each network that allows the UEs 10 to be onboarded and be authenticated by that UE manufacturer broadcasts the GID of the UE manufacturer and sets the type parameter in SIB to the value “Onboarding”. The term “Onboarding” refers to enabling connectivity to the UE 10 for realizing remote provisioning, and in some cases the term “Onboarding” includes both enabling the connectivity as well as the remote provisioning of the UE 10 with NPN credentials. This allows a network to purchase devices from that manufacturer, so that the devices can automatically recognize the manufacturer GID in the SIB and attempt the Onboarding for being remotely provisioned.
2. The UE manufacturer builds a number of UEs 10 designed for a group of federated networks, the federation being identified with a given GID. The manufacturer configures the firmware of the UEs 10 with the GID allocated to the federation of networks. Each network in the group broadcasts that GID along with the type parameter set to “Onboarding”. The UE 10 can automatically recognize the GID in the SIB along with the Type “Onboarding” as the GID imprinted in the firmware, to be used for onboarding purposes.
3. A vertical enterprise allows some of its providers to connect the UEs 10 to the vertical network, without requiring enrollment in the vertical network. This is achieved by the vertical network delegating the authentication and authorization of UEs owned by the providers to the provider's network. To enable this use case, the vertical network broadcasts the GID pertaining to the provider, or pertaining to a group of providers, along with the type parameter indicating “3^{rd} party SP”. The term “3^{rd} party SP” refers to a credential holder, different from the NPN, or vertical network in this example, and which provides the UE 10 with subscription credentials for granting access to a network. The UEs 10 are configured with credentials of the provider's network. The UEs 10 are also configured to recognizing such GID for delegated authentication and authorization purposes. This enables the UE 10 to automatically recognize the configured GID and select the vertical network broadcasting such GID.
4. This is a combined use case, where the UEs 10 that are acquired by the supplier can also onboard to their vertical network. In this case, the vertical broadcasts the GID of the provider along with a type parameter set to both “3^{rd} party SP” and “Onboarding”. This enables the UE 10 to either attempt registration into the vertical network, supplying credentials owned by the providers network, or, alternatively, attempt to onboard to the vertical network, for the purpose of the vertical network to remotely provisioning new credentials, owned by the vertical network.

Table 1 provides a summary of use cases, indicating the information configured in the UE 10, the information broadcast in SIB, and the capability they offer.

TABLE 1
Summary of Use Cases

| Use | | GID broadcast | Type parameter | |
|---|---|---|---|---|
| case | GID in UE | in SIB | broadcast in SIB | Capability |
| 1 | Manufacturers | Manufacturers | Onboarding | Onboarding |
| | GID | GID | | |
| 2 | Federation of | Federation of | Onboarding | Onboarding |
| | Networks GID | Networks GID | | |
| 3 | Provider GID | Provider GID | 3^{rd} party SP | 3^{rd} party SP |
| 4 | Provider with | Provider with | 3rd party SP, | 3rd party SP, |
| | onboarding | onboarding | Onboarding | Onboarding |
| | support GID | support GID | | |

On the other hand, by solely indicating the GID(s) supported by the network in the SI, unnecessary information can be avoided from the broadcast allowing a better utilization of the network resources and also facilitating/accelerating the network selection process to UEs 10. The benefit of one embodiment is that, since the GID reuses the existing Network Identifier (NID), there is no need including the PLMN as part of the GID, thus, saving bits in the SIB.

The benefit of another embodiment, in which the type parameter is embedded into the NID, is that there is no need for broadcasting it separately, thus, saving even more bits in the SIB. With the above embodiments, the networks only need to broadcast the NID of the group of networks for which services are provided if the PLMN ID is not needed to ensure global uniqueness of the GID. For some cases, the PLMN ID may still need to be included.

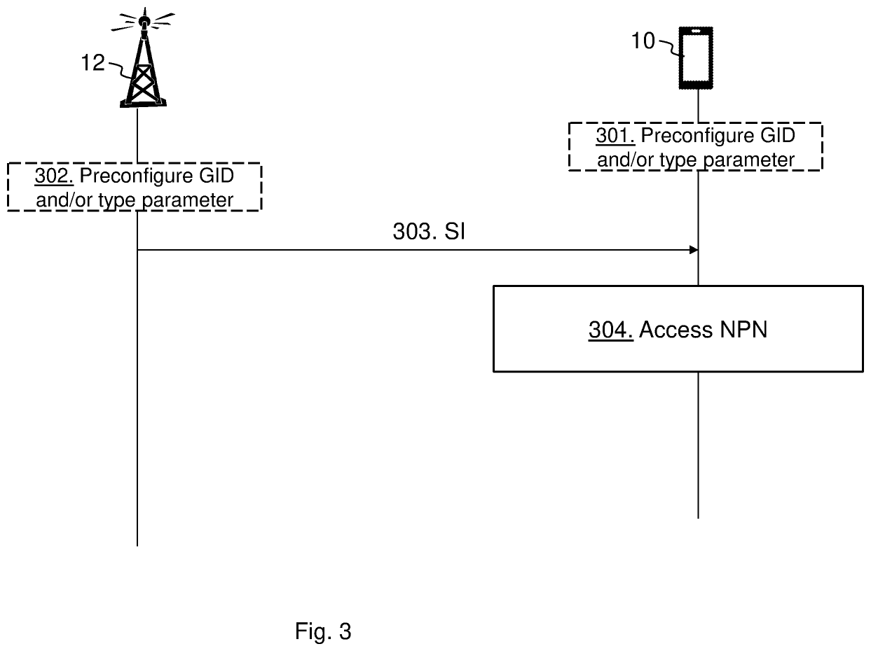

FIG. 3 is a combined signalling and flowchart scheme according to embodiments herein.

Action 301. The UE 10 may be preconfigured with the GID and/or the one or more type parameters represented by a list and/or a bitmap. The configuration in the UE 10 may be updated by the core network at any time. The service of interest may be triggered by the end user or may be pre-configured in the UE 10, e.g., onboarding should be pre-configured.

Action 302. The radio network node 12 may be preconfigured with the GID and/or the one or more type parameters represented by the list and/or the bitmap.

Action 303. The radio network node 12 transmits, or broadcasts, SI, wherein the SI comprises the type parameter associated with the GID, wherein the type parameter indicates the type of service offered by one or more networks identified by the GID. The type parameter may be a bit value in a bitmap, a boolean and/or an index in a list of networks.

Action 304. The UE 10 receives the SI and uses the type parameter for selecting and accessing a network associated with the GID and the service, which the UE 10 is configured with.

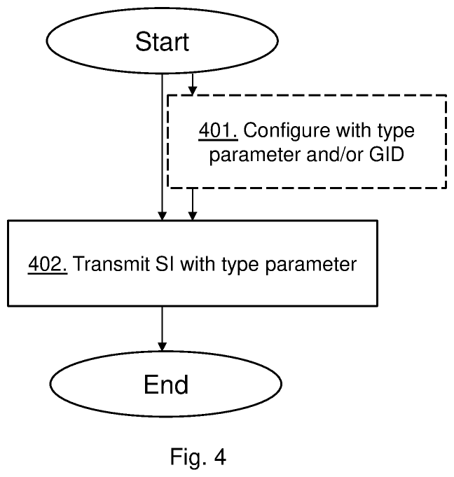

The method actions performed by the radio network node 12 for handling communication in the wireless communications network 1 according to embodiments will now be described with reference to a flowchart depicted in FIG. 4. The actions do not have to be taken in the order stated below but may be taken in any suitable order. Dashed boxes indicate optional features.

Action 401. The radio network node 12 is preconfigured with the GIDs and/or the type parameter.

Action 402. The radio network node 12 transmits, for example, broadcasts, the SI with the type parameter associated with the GID, wherein the type parameter indicates the type of service offered by one or more networks identified by the GID. The radio network node 12 may further transmit, or broadcast, the GID. The type parameter may be represented by a separate service type indication in GID-Info. The type parameter may be represented by an indicator bitmap in which each of the bits represents a different service provided by the network. The type parameter may be represented by a list or sequence of booleans, in which each boolean represents a different service. The type parameter may be represented by a service index which indicates one or more supported services from a pre-defined list of services. The service indexes may be pre-configured in the UE 10. The type parameter may be represented by an INTEGER or index value which points to a specific service or service combination from a list of predefined services that may be provided by a network. The type parameter may be represented by a service type indication, GID type, encoded into the GID or GID value. The type parameter may be represented by a sequence of bits that corresponds to a codeword from a codebook of services or service combinations. The UE 10 may need to be pre-configured with this codebook, otherwise, the UE 10 would not know the mapping from the codeword to the service combination. Thus, the UE 10 may be pre-configured with a codebook; and/or service indexes. The type parameter may be implicitly provided by specific encoding of the GID. The GID encoding itself may be optimized to avoid broadcasting the PLMN ID when the remaining GID value is sufficient for non-ambiguous network selection. The type parameter may be broadcast in SIB along with the GID to which it is associated.

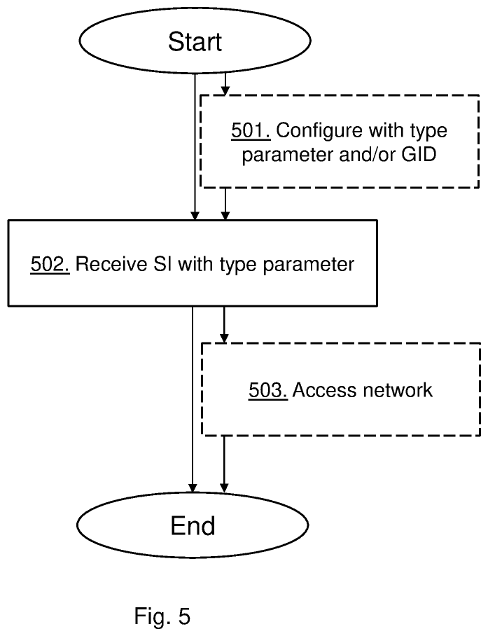

The method actions performed by the UE 10 for handling communication in the wireless communications network 1 according to embodiments will now be described with reference to a flowchart depicted in FIG. 5. The actions do not have to be taken in the order stated below, but may be taken in any suitable order. Dashed boxes indicate optional features.

Action 501. The UE 10 is preconfigured with the GIDs and/or the type parameter, for example, before the UE 10 reads the SI.

Action 502. The UE 10 receives SI with the type parameter associated with the group identity, wherein the type parameter indicates the type of service offered by one or more networks identified by the GID. The type parameter may be represented by a separate service type indication in GID-Info. The type parameter may be represented by an indicator bitmap in which each of the bits represents a different service provided by the network. The type parameter may be represented by a list or sequence of booleans, in which each boolean represents a different service. The type parameter may be represented by a service index which indicates the one or more supported services from a pre-defined list of services. The service indexes may be pre-configured in the UE 10. The type parameter may be represented by an INTEGER or index value which points to a specific service or service combination from a list of predefined services that may be provided by a network. The type parameter may be represented by a service type indication, GID type, encoded into the GID or GID value. The type parameter may be represented by a sequence of bits that corresponds to a codeword from a codebook of services or service combinations. The UE 10 may need to be pre-configured with this codebook, otherwise, the UE 10 would not know the mapping from the codeword to the service (combination). Thus, the UE 10 may be pre-configured with a codebook; and/or service indexes. The type parameter may be implicitly provided by specific encoding of the GID. The GID encoding itself may be optimized to avoid broadcasting the PLMN ID when the remaining GID value is sufficient for non-ambiguous network selection. The type parameter may be broadcasted in SIB along with the GID to which it is associated.

Action 503. The UE 10 may then use the type parameter to access a network. For example, the UE 10 may select one of the networks it is allowed to access, based on the GID(s) the UE 10 is configured with and the type parameter. For example, the UE 10 may select the network which corresponds to the associated network ID and the type parameter.

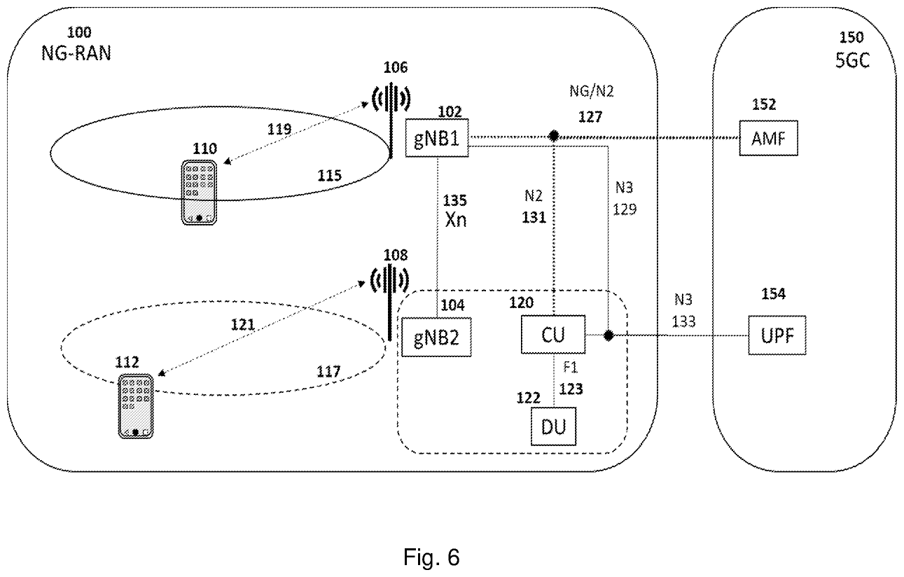

FIG. 6 shows an exemplary 5G communication system comprising 5GC and NG-RAN.

FIG. 6 illustrates an exemplary communication system pursuant to 3GPP specifications for fifth generation core (5GC) 150 and 5G Radio Access Network (NG-RAN) (100 as described in, e.g., 3GPP TS 23.501 [3], TS 38.300 [4] and TS 38.401 [5].

The 5G-RAN or NG-RAN consists of gNBs 102,104 that connects to antenna elements 106, 108 via which wireless communication 119, 121 is possible to/from UEs 110, 112 within a certain coverage area 115, 117. The interface between the gNB 102,104 and the UE 110, 112 is sometimes referred to as the Uu interface. Different gNBs can connect to each other via a direct interface referred to as Xn 135 interface. This interface is typically used for mobility between different gNBs, e.g., when UE's move between different coverage areas served by different gNBs. In the FIG. 6 gNB2 104 is illustrated with additional details in how it may be built-up. A gNB may consist of a Central Unit (CU) 120 and at least one Distributed Unit (DU) 122. The CU 120 can connect with the DU 122 via an F1 interface 123. The gNBs 102, 104 are then connected to two different nodes in the 5G Core network, one for the user plane traffic and one for control plane traffic. The interface for control plane NG/N2 127, 131 towards an Access and Mobility management Function (AMF), 152 and the interface for user plane traffic N3, 129, 133 for communication towards a User Plane Function (UPF) 154. The standard describes, e.g., N5, N7, etc, to be the reference point between two nodes/end points, synonymous to interface as it is sometimes done also in specifications. The connection to the core network goes in the illustration via the CU in the gNB, as exemplified by gNB2 104 and CU 120. It is the role of the gNB to terminate the control signaling that establishes and controls the air interface connection towards the UE. It is further the role to be the communication point towards the radio access network 100 for the core network 150. While the interfaces have been denoted with, e.g., N5, N7 etc in the figure (N+number) this is usually referring to a reference point between the different nodes, in this description the same denotations will be used to denote the interfaces between the entities in its entirety.

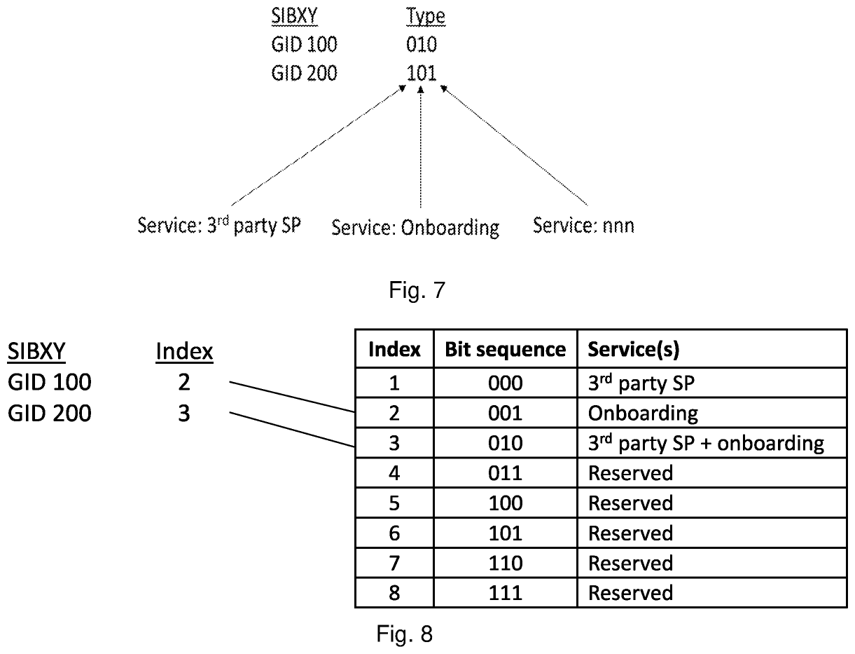

Thus, the type parameter may be broadcasted, e.g., in a SIB, along each GID. This is illustrated in FIG. 7. The type parameter may be a bitmask used for identifying the services provided by each network integrated in the GID. In this example, a first bit indicates the capability of the network or service provider represented by the GID to provide authentication services with credentials supplied by that provider, which is referred to in its shorter form as 3^{rd} party SP. A second bit is used to represent the capability of the network to provide authentication for onboarding services, which is referred to in its shorter form as Onboarding. Other bits, if added, can be reserved for future use denoted as nnn.

An ASN.1 representation of the type parameter is illustrated below.

ASN.1 example for type parameter using a bitmap approach.

| GID-Info-r17 ::= | SEQUENCE { | |
|---|---|---|
| gid | GID | |
| type | BIT STRING (SIZE (maxGID-Types) | OPTIONAL, -- Need R |

```
  ...
}
  type
  Indicates the (service) types that a GID is associated with. The GID can identify a
group of networks, servers (e.g. provisioning or default credential servers), or any kind of
entities. The first/leftmost bit indicates that these entities support authentication using
credentials from any of these entities (3^{rd} party SP), the second bit refers to onboarding
service support (Onboarding). A bit set to ‘1’ means that any network integrated in the
group of GID supports the service. In this release of the specification, the remaining bits
are reserved for future use and are in this release expected to be 0.
```

ASN.1 example for type parameter using a list with service indicators.

| GID-Info-r17 ::= | SEQUENCE { | |
|---|---|---|
| gid | GID | |
| type | SEQUENCE { | |
| authentication | ENUMERATED {true} | OPTIONAL, -- Need R |
| onboarding | ENUMERATED {true} | OPTIONAL, -- Need R |

```
      ...
    }
  ...
}
```

The extension markers, i.e., the three dots “ . . . ”, illustrated above indicate that the list may be extended. In reality, such extension is typically not used in lists that are broadcast as these will create extra signaling costs when extended.

Alternatively, the type parameter may be represented by a codeword taken from a codebook of services, i.e., the codeword is basically an index pointing to a specific predefined service or service combination, where each codeword/index is a bit sequence or combination of bits. In this sense, such an approach allows to signal a larger number of services with a smaller number of bits. This is illustrated in FIG. 8. The corresponding ASN.1 encoding example is provided below. FIG. 8 illustrates wherein type parameter is associated to each GID using an index within a pre-defined table.

ASN.1 example for the type parameter using a codebook (type index).

| GID-Info-r17 ::= | SEQUENCE { | |
|---|---|---|
| gid | GID | |
| typeIndex | INTEGER (1..maxServTypes) | OPTIONAL, -- Need R |

...
}

| | | |
|---|---|---|
| maxServTypes | INTEGER ::= 8 | -- Maximum number of service types for GIDs |

typeIndex
Indicates the (service) types that a GID is associated with. The index to service type(s)
mapping is defined in Table 2.

TABLE 2
(Type) index to service type mapping (taken
from FIG. 8) statically configured in the specification.

| Codeword | | |
|---|---|---|
| (Type index) | Bit sequence | Service Type(s) |
| 1 | 000 | Onboarding |
| 2 | 001 | Authentication services by 3^{rd} party SP |
| 3 | 010 | Onboarding & authentication |
| . . . | . . . | . . . |
| 8 | 111 | Reserved service |

The indexing can also start at INTEGER value 0:

ASN.1 example for the type parameter using a codebook (type index).

| GID-Info-r17 ::= | SEQUENCE { | |
|---|---|---|
| gid | GID | |
| typeIndex | INTEGER (0..maxServTypes−1) | OPTIONAL, -- Need R |

...
}

| | | |
|---|---|---|
| maxServTypes | INTEGER ::= 8 | -- Maximum number of service types for GIDs |
| maxServTypes−1 | INTEGER ::= 7 | -- Maximum number of service types for GIDs minus 1 |

typeIndex
Indicates the (service) types that a GID is associated with. The index to service type(s)
mapping is defined in Table 2.

TABLE 3
(Type) index to service type mapping statically configured
in the specification with index starting from value 0.

| Codeword | Bit | |
|---|---|---|
| (Type index) | sequence | Service Type(s) |
| 0 | 000 | Onboarding |
| 1 | 001 | Authentication services by 3^{rd} party SP |
| 2 | 010 | Onboarding & authentication |
| . . . | . . . | . . . |
| 7 | 111 | Reserved service |

Alternatively, in order to avoid broadcasting explicitly which service types are supported by the GIDs, the type parameter may, as in the previous option, be represented by a codeword taken from a codebook of services where each combination of bits points to a specific predefined service or service combination. This mapping is not fixed in the specification but is pre-configured in the UE 10, and the configuration can be updated. So only the UEs 10 which are configured with such a codebook as illustrated in Table 4 may obtain the information which service types are associated with a given GID.

TABLE 4
Exemplary codebook for service type mapping
pre-configured in the UE 10.

| Codeword | Broadcasted | |
|---|---|---|
| (Type index) | value | Service Type(s) |
| S₀ (010) | 2 | Onboarding |
| S₁ (110) | 6 | Authentication services by 3^{rd} party SP |
| S₂ (001) | 1 | Onboarding & authentication |
| . . . | | . . . |
| S₇ (100) | 4 | Reserved service |

Network identifier signalling optimization.

As described in the background, the GID may use the same encoding as an SNPN ID, i.e., to be composed by a PLMN ID, plus a NID. The ASN.1 code for the GID would look as follows in accordance with the current TR 23.700-07 [1] is illustrated below.

ASN.1 example for the GID according
to the current state of the art.

| GID-r17 | SEQUENCE { |
|---|---|
| plmn-Identity-r17 | PLMN-Identity, |
| gid-Value-r17 | GID-Value-r17 |
| } | |
| GID-Value-r17 ::= | BIT STRING (SIZE (44)) |

There are three possible assignments modes represented in the NID's format:
the NID is globally unique independent of the PLMN ID (Assignment mode 0);
the NID+PLMN ID are globally unique (Assignment mode 2)
a self-managed mode, where the value is not globally unique (Assignment mode 1).

As stressed out above, UEs configured with GIDs, in fact use these group identities for network selection. Moreover, a GID identifies a collection of SPs such as, e.g., a multi-national operator to associate all the national operating companies which have different PLMN IDs. Interconnection providers provide connectivity towards totally independent private networks, which may not even have a unique PLMN ID and use MCC=999.

Thus, considering the above, there is no actual need to include the PLMN ID in the GID. Therefore, the solution provided by this embodiment identifies the GID with the NID part only.

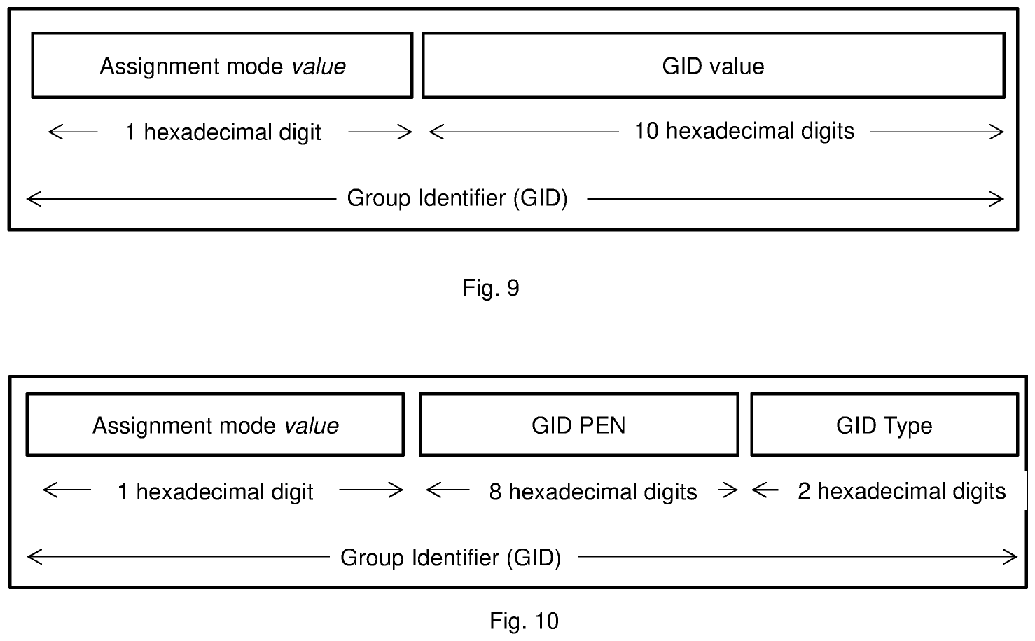

FIG. 9 illustrates the encoding of the Network ID to define a GID according to the embodiment hereby described. Accordingly, the structure of the NID becomes:
4 bits (one hexadecimal digit) indicating the assignment mode. A new assignment mode value may be allocated.
40 bits indicating the GID of a collection of networks.

For the self-managed assignment mode (assignment mode 1), it may still be beneficial to keep the PLMN ID to reduce the probability of non-unique GID values.

Thus, the broadcast may include the PLMN ID for assignment mode 1 and 2, while it would be omitted for assignment mode 0. This is illustrated in below.

| GID-r17 | SEQUENCE { | |
|---|---|---|
| plmn-Identity-r17 | PLMN-Identity | OPTIONAL, -- Cond non-unique |

| | |
|---|---|
| gid-List-r17 | SEQUENCE (SIZE (1..maxGIDs-r17)) OF GID-Value-r17 |

}

| | |
|---|---|
| GID-Value-r17 ::= | BIT STRING (SIZE (44)) |

```
  plmn-Identity
  Identifies a Public Land Mobile Network. Further information regarding how to set
the IE is specified in TS 23.003.
```

| Conditional Presence | Explanation |
|---|---|
| non-unique | This field is optionally/mandatory |
| | present when the GID |
| | value is not globally unique, see |
| | TS 23.003. Otherwise it is |
| | absent, Need R. |

Optionality of PLMN ID added when globally non-unique GID values may be assigned.

Type parameter encoding embedded into NID.

An encoding of the type parameter in SIB will now be described. The benefit of this embodiment is that it does not require separate broadcast of type parameter, and as a consequence, reducing interference and improving the overall performance of the radio access network.

The “NID code” can be further used to identify the services within the private enterprise instead of using the service type. The solution provided by this embodiment consists of:
Identifying the GID with a Private Enterprise Number (PEN)
Including the type as part of the NID

Above illustrates the encoding of the NID according to the previous embodiment in which the GID is also embedded into the NID, plus the embodiment hereby described. According to this embodiment, the structure of the GID becomes:
4 bits (one hexadecimal digit) indicating the assignment mode. A new assignment mode value may be allocated.
32 bits (8 hexadecimal digits) for “GID PEN” indicating a GID of a collection of networks identified by a PEN. The PEN identifies the group of networks and thus represents the Group ID, GID.
8 bits (2 hexadecimal digits) for the “GID Type” indicating the (Service) type parameter, containing the bitmask or codebook of the offered services.

FIG. 10 shows GID encoding and structure according to an embodiment.

In principle, the bits can be mapped differently, e.g., GID PEN could be represented by 9 hexadecimal digits, while the GID type would be represented by only 1 hexadecimal digit. However, the above example was shown to maximize the reuse of the existing NID format. In general, if e.g. the last n bits within the GID are used to represent the service type, there would be 2ⁿ possible service types.

UE behavior using the type parameter.

The UE 10 may be configured with a GID and when performing network selection, it may scan and detect available networks. The UE 10 may then detect broadcast of network IDs and broadcast of GID information.

The UE 10 may compare the GIDs it is configured with, with the broadcasted GIDs contained in the gid-InfoList. If the UE 10 finds the GID in a GID-Info entry, the UE 10 may then read which services are associated with this GID based on the type parameter.
a) The UE 10 may use the type parameter, e.g., bitmap, index list, index, or codeword, that is broadcast in the GID-Info together with the GID to determine whether its service of interest is supported.

The UE 10 may read the service type encoded into the GID

The UE 10 may only need to detect the broadcast of the GID it is configured with in order to decide whether its service of interest is supported.

The UE 10 may select among the network(s) it is allowed to access based on the GID(s) and service(s) it is configured with.

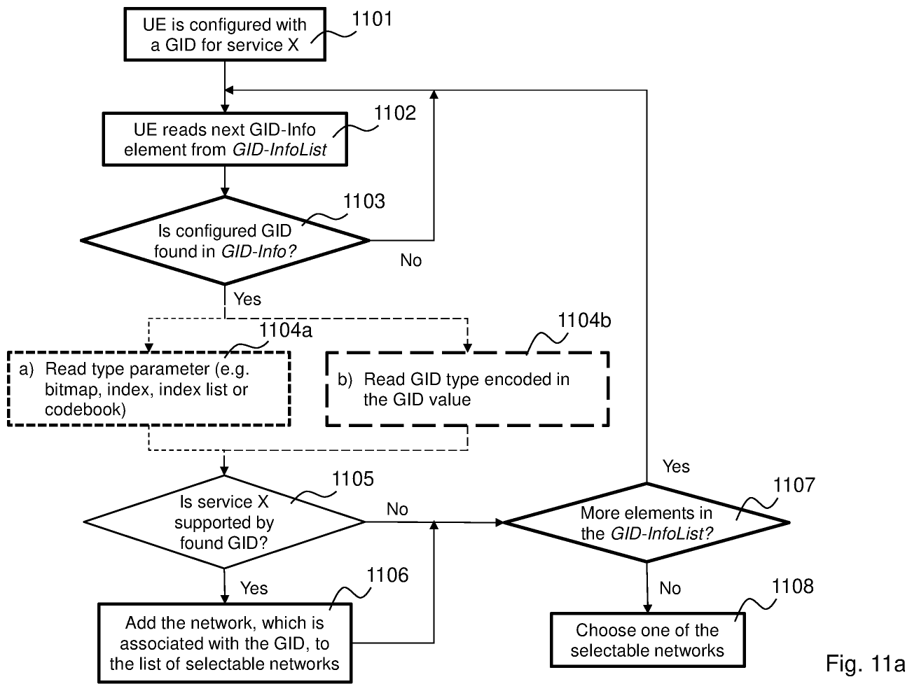

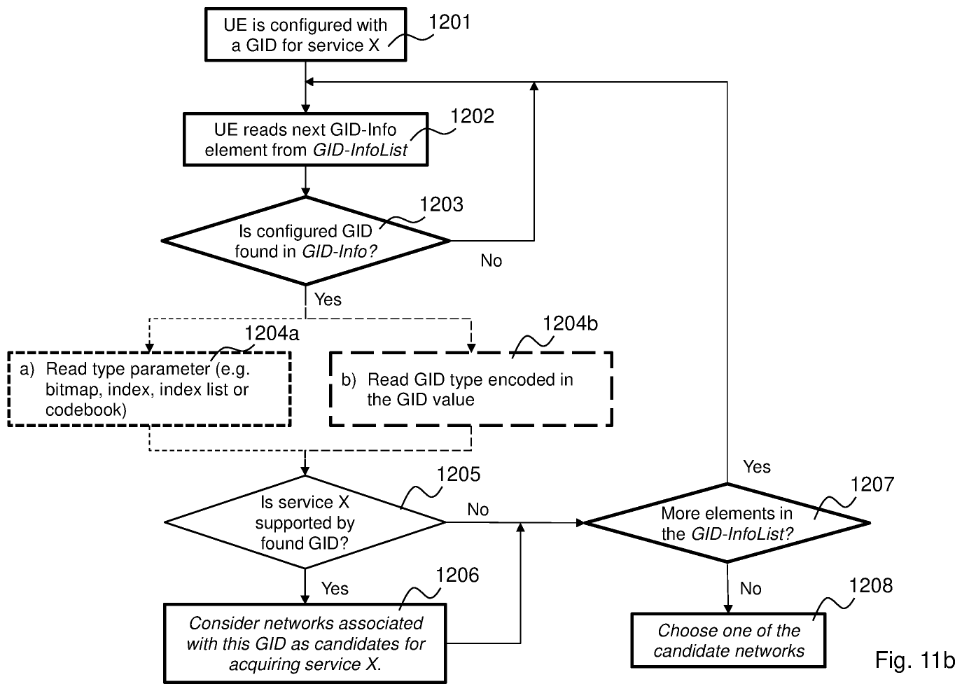

This procedure is illustrated in FIG. 11a. UE behavior for network selection using GID and service information.

The UE 10 may be configured with a GID with a service type X, see action 1101, it can scan and detect available networks. The UE 10 then reads next GID-Info element from GID-InfoList, see action 1102. Now, the UE 10 may, by comparing the GID(s) it is configured with, with the broadcasted GIDs contained in the GID-InfoList also detect which networks are available for selection. The UE 10 may thus determine whether the configured GID is found in GID-Info, action 1103. If the UE 10 finds the GID in a GID-Info entry, the UE 10 may read the type parameter, e.g., bitmap, index, index list or codebook, see action 1104a). Alternatively, the UE 10 finds the GID in a GID-Info entry, and the UE 10 may read the type parameter (GID type) encoded in the GID value, see action 1104b). The UE 10 may then determine whether the service type X is supported by the found GID, action 1105. That being the case, the UE 10 may add the network, which is associated with the GID, to the list of selectable networks, see action 1106. The UE 10 may check whether there are more elements in the GID-InfoList, see action 1107. If there are more elements the flow turns back to read the next GID-Info element from GID-InfoList. If there are not more elements, the UE 10 may choose one of the selectable networks, see action 1108.

### EXAMPLES

i) The UE 10 is configured with 3^{rd} party credentials

In one specific case, the UE 10 is equipped with credentials from a 3^{rd} party SP, and these credentials can be used to access certain SNPNs, i.e. SNPNs supporting authentication by this 3^{rd} party SP. Additionally, the UE 10 is configured with a GID that comprises identification of this 3^{rd} party SP. The UE 10 also needs to check whether the GID that it has found in the GID-Info supports this GID supports 3^{rd} party SPs. If so, the UE 10 may select among the network(s) it is allowed to access based on the GID(s) and the 3^{rd} party SP services it is configured with.

ii) The UE 10 is configured with onboarding parameters

In another case, the UE 10 may be configured with a GID and onboarding parameters. In that case, the UE 10 may need to check whether the GID that it has found in the GID-Info supports onboarding services based on the type parameter in the SI.

For future services, networks may be selectable even if they do not support a certain GID and or service X. A more general flowchart is provided in FIG. 11b.

The UE 10 may be configured with a GID with a service type X, see action 1201, it can scan and detect available networks. The UE 10 then reads next GID-Info element from GID-InfoList, see action 1202. Now, the UE 10 may, by comparing the GID(s) it is configured with, with the broadcasted GIDs contained in the GID-InfoList also detect which networks are available for selection. The UE 10 may thus determine whether the configured GID is found in GID-Info, action 1203. If the UE 10 finds the GID in a GID-Info entry, the UE 10 may read the type parameter, e.g., bitmap, index, index list or codebook), see action 1204a). Alternatively, the UE 10 finds the GID in a GID-Info entry, and the UE 10 may read the type parameter, e.g. GID type, encoded in the GID value, see action 1204b). The UE 10 may then determine whether the service type X is supported by the found GID, action 1205. That being the case, the UE 10 may consider networks associated with this GID as candidates for acquiring service X, see action 1206. The UE 10 may check whether there are more elements in the GID-InfoList, see action 1207. If there are more elements the flow turns back to read the next GID-Info element from GID-InfoList. If there are not more elements, the UE 10 may then choose one of the candidate networks, see action 1208.

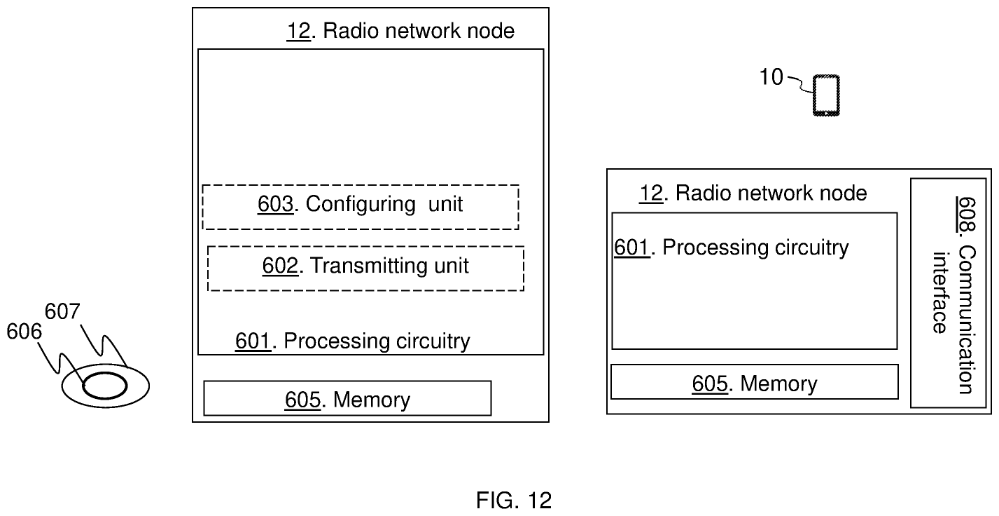

FIG. 12 is a block diagram depicting the radio network node 12 for handling communication in the wireless communications network 1 according to embodiments herein.

The radio network node 12 may comprise processing circuitry 601, e.g. one or more processors, configured to perform the methods herein.

The radio network node 12 may comprise a transmitting unit 602, e.g. a transmitter or a transceiver. The radio network node 12, the processing circuitry 601 and/or the transmitting unit 602 is configured to transmit, e.g., broadcast, the SI to one or more UEs. The SI comprises the type parameter associated with the GID, wherein the type parameter indicates the type of service offered by one or more networks identified by the GID. The type parameter may be represented by a separate service type indication in GID-Info. The type parameter may be represented by an indicator bitmap in which each of the bits represents a different service provided by the network. The type parameter may be represented by a list or sequence of booleans, in which each boolean represents a different service. The type parameter may be represented by a service index which indicates the one or more supported services from a pre-defined list of services. The service indexes may be pre-configured in the UE 10. The type parameter may be represented by an INTEGER or index value which points to a specific service or service combination from a list of predefined services that may be provided by a network. The type parameter may be represented by a service type indication (“GID type”) encoded into the GID or GID value. The type parameter may be represented by a sequence of bits that corresponds to a codeword from a codebook of services or service combinations. The type parameter may be implicitly provided by specific encoding of the GID. The GID encoding itself may be optimized to avoid broadcasting the PLMN ID when the remaining GID value is sufficient for non-ambiguous network selection. The type parameter may be broadcasted in SIB along with the GID to which it is associated.

The radio network node 12 may comprise a configuring unit 603, e.g. a transmitter or a transceiver. The radio network node, the processing circuitry 601 and/or the configuring unit 603 is preconfigured with the GID and/or the type parameter.

The radio network node 12 may comprise a memory 605. The memory 605 comprises one or more units to be used to store data on, such as data packets, type parameter, GIDs, networks, mobility events, measurements, sizes related to types of data transmissions, events and applications to perform the methods disclosed herein when being executed, and similar.

Furthermore, the radio network node 12 may comprise a communication interface 608 such as comprising a transmitter, a receiver, a transceiver and/or one or more antennas.

The methods according to the embodiments described herein for the radio network node 12 are respectively implemented by means of e.g. a computer program product 606 or a computer program, comprising instructions, i.e., software code portions, which, when executed on at least one processor, cause the at least one processor to carry out the actions described herein, as performed by the radio network node 12. The computer program product 606 may be stored on a computer-readable storage medium 607, e.g. a disc, a universal serial bus (USB) stick or similar. The computer-readable storage medium 607, having stored thereon the computer program product, may comprise the instructions which, when executed on at least one processor, cause the at least one processor to carry out the actions described herein, as performed by the radio network node 12. In some embodiments, the computer-readable storage medium may be a transitory or a non-transitory computer-readable storage medium. Thus, embodiments herein may disclose a radio network node 12 for handling communication in a wireless communications network, wherein the radio network node 12 comprises processing circuitry and a memory, said memory comprising instructions executable by said processing circuitry whereby said radio network node 12 is operative to perform any of the methods herein.

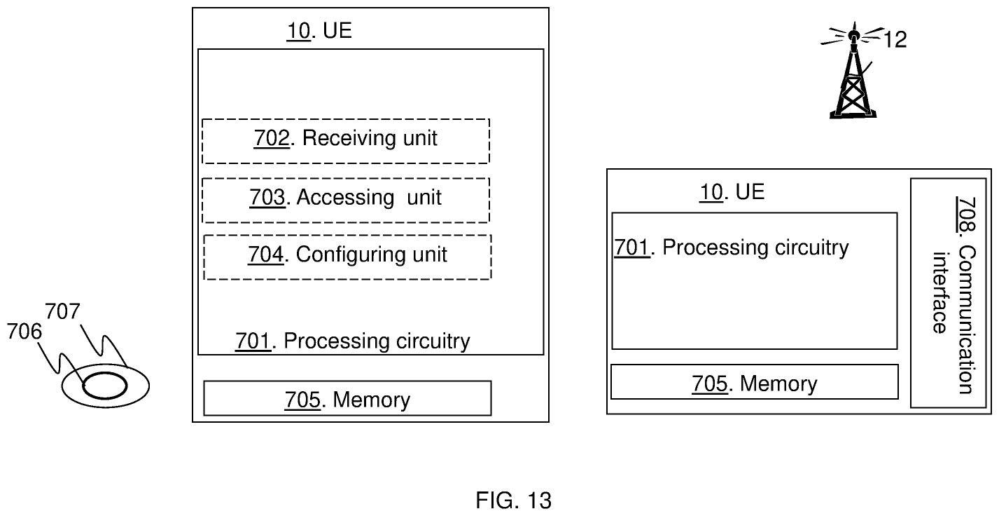

FIG. 13 is a block diagram depicting the UE 10 for handling communication in the wireless communications network 1 according to embodiments herein.

The UE 10 may comprise processing circuitry 701, e.g. one or more processors, configured to perform the methods herein.

The UE 10 may comprise a receiving unit 702, e.g. a reader, a receiver or a transceiver. The UE 10, the processing circuitry 701 and/or the receiving unit 702 is configured to receive the SI from the radio network node 12. The SI comprises the type parameter associated with the GID, wherein the type parameter indicates the type of service offered by one or more networks identified by the GID. The type parameter may be represented by a separate service type indication in the GID-Info. The type parameter may be represented by an indicator bitmap in which each of the bits represents a different service provided by the network. The type parameter may be represented by a list or sequence of booleans, in which each boolean represents a different service. The type parameter may be represented by a service index which indicates the one or more supported services from a pre-defined list of services. The service indexes may be pre-configured in the UE 10. The type parameter may be represented by an INTEGER or index value which points to a specific service or service combination from a list of predefined services that may be provided by a network. The type parameter may be represented by a service type indication, GID type, encoded into the GID or GID value. The type parameter may be represented by a sequence of bits that corresponds to a codeword from a codebook of services or service combinations. A UE 10 may need to be pre-configured with this codebook, otherwise, the UE 10 would not know the mapping from the codeword to the service combination. Thus, the UE 10 may be pre-configured with a codebook; and/or service indexes. The type parameter may be implicitly provided by specific encoding of the GID. The GID encoding itself may be optimized to avoid broadcasting the PLMN ID when the remaining GID value is sufficient for non-ambiguous network selection. The type parameter may be broadcasted in SIB along with the GID to which it is associated.

The UE 10 may comprise an accessing unit 703, e.g., a transmitter or a transceiver. The UE 10, the processing circuitry 701 and/or the accessing unit 703 may be configured to access the network based on the type parameter. E.g., the UE 10, the processing circuitry 701 and/or the accessing unit 703 may be configured to select a network to access corresponding to the network associated with the GID configured at the UE 10 and type parameter corresponding to a desired service. The UE 10, the processing circuitry 701 and/or the accessing unit 703 may be configured to use the type parameter to access a network. For example, the UE 10, the processing circuitry 701 and/or the accessing unit 703 may be configured to select one of the networks it is allowed to access, based on the GID(s) the UE 10 is configured with and type parameter. For example, the UE 10, the processing circuitry 701 and/or the accessing unit 703 may be configured to select network which corresponds to the associated network ID and the type parameter.

The UE 10 may comprise a configuring unit 704. The UE 10, the processing circuitry 701 and/or the configuring unit 704 may be configured to receive preconfiguration data to configure the type parameter and/or the GID, at the UE 10.

The UE 10 may comprise a memory 705. The memory 705 comprises one or more units to be used to store data on, such as data packets, grants, type parameter(s), indices, GIDs, bitmap, indications, mobility events, measurements, events and applications to perform the methods disclosed herein when being executed, and similar. Furthermore, the UE 10 may comprise a communication interface 708 such as comprising a transmitter, a receiver, a transceiver and/or one or more antennas.

The methods according to the embodiments described herein for the UE 10 are respectively implemented by means of e.g. a computer program product 706 or a computer program, comprising instructions, i.e., software code portions, which, when executed on at least one processor, cause the at least one processor to carry out the actions described herein, as performed by the UE 10. The computer program product 706 may be stored on a computer-readable storage medium 707, e.g. a disc, a universal serial bus (USB) stick or similar. The computer-readable storage medium 707, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in a wireless communications network, wherein the UE 10 comprises processing circuitry and a memory, said memory comprising instructions executable by said processing circuitry whereby said UE 10 is operative to perform any of the methods herein.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

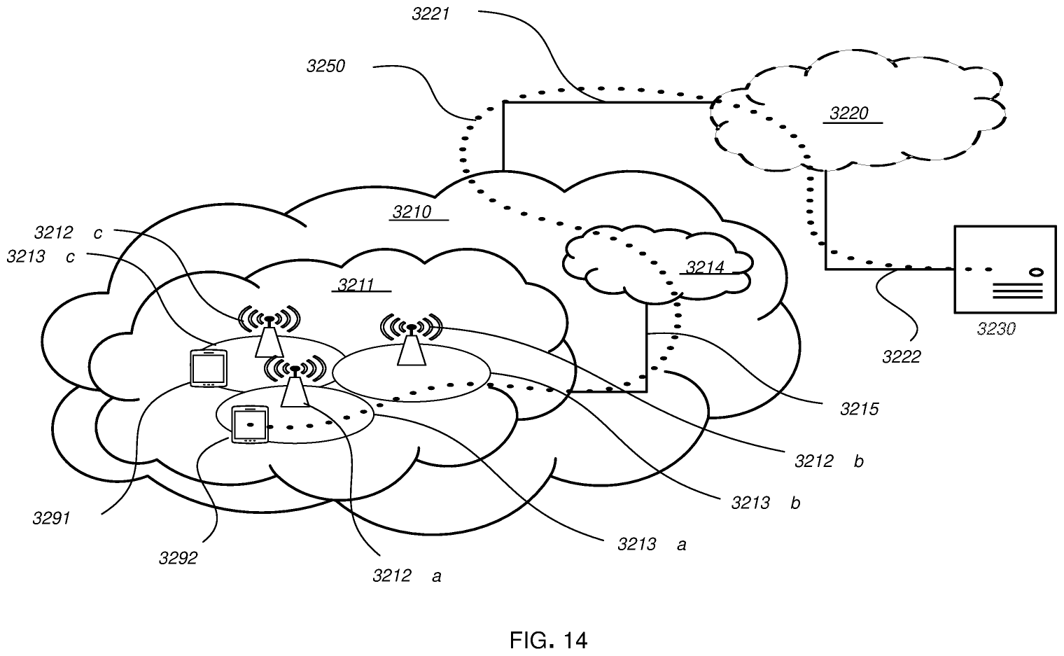

With reference to FIG. 14, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10 and relay UE 13, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 14 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

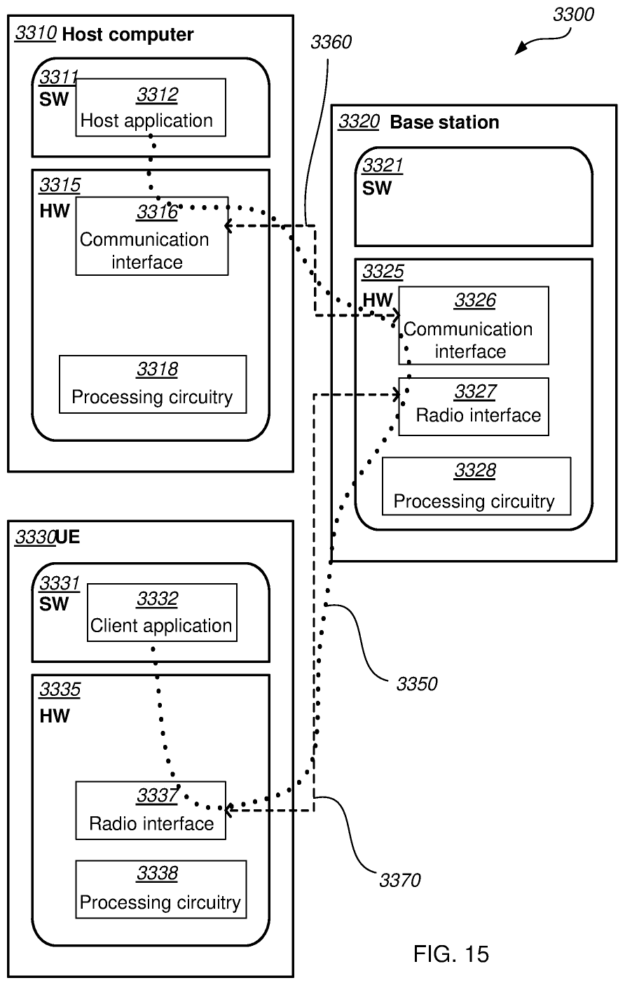

Example implementations, in accordance with an embodiment, of the UE, base station and host computer discussed in the preceding paragraphs will now be described with reference to FIG. 15. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 15) served by the base station 3320. The communication interface 3326 may be configured to facilitate a connection 3360 to the host computer 3310. The connection 3360 may be direct or it may pass through a core network (not shown in FIG. 15) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 15 may be identical to the host computer 3230, one of the base stations 3212a, 3212b, 3212c and one of the UEs 3291, 3292 of FIG. 14, respectively. This is to say, the inner workings of these entities may be as shown in FIG. 15 and independently, the surrounding network topology may be that of FIG. 14.

In FIG. 15, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since SI is transmitted more efficiently and thereby provide benefits such as reduced user waiting time, and better responsiveness since interference is reduced.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

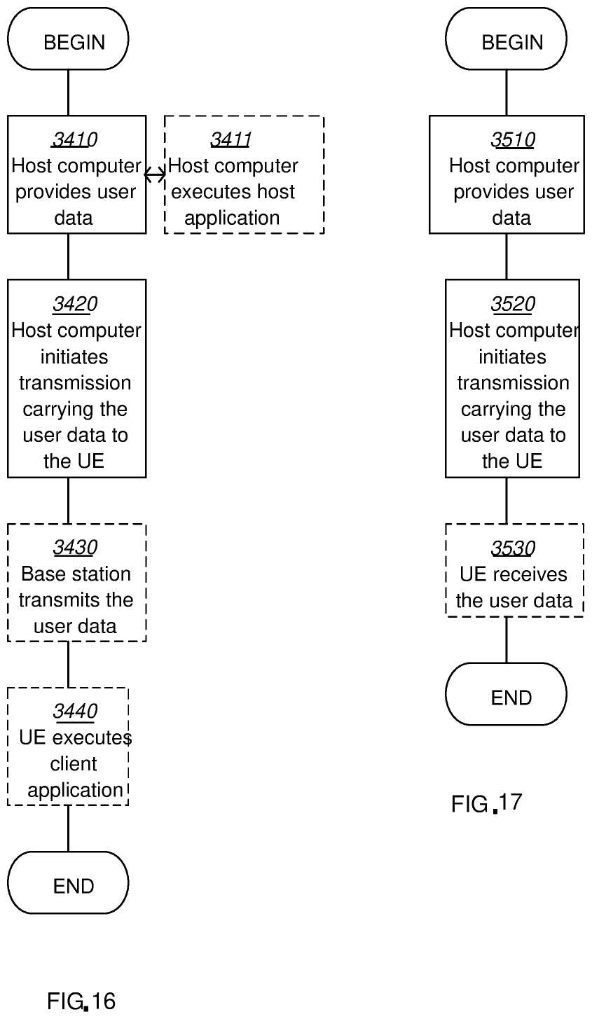

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

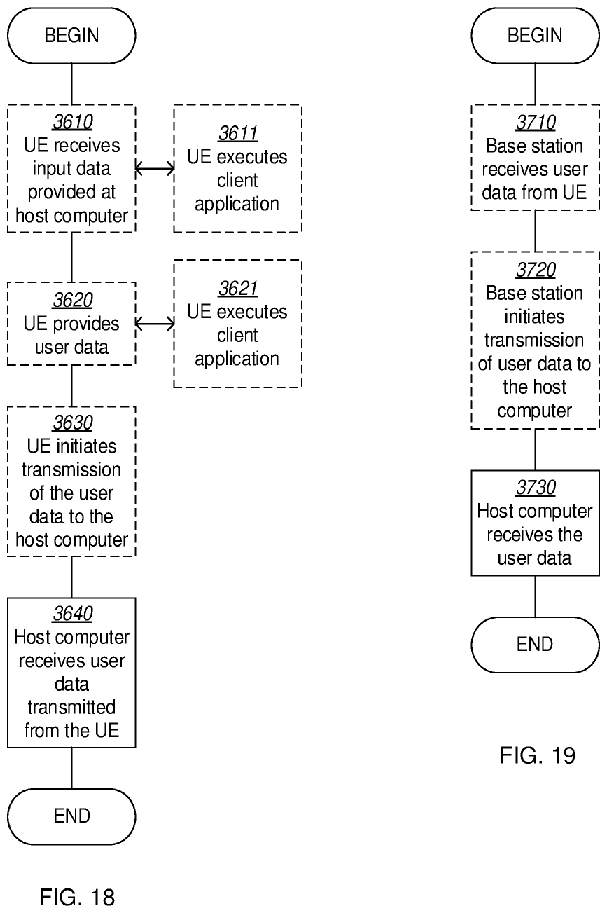

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

### ABBREVIATION EXPLANATION

5GC 5th Generation Core Network
AMF Access and Mobility management Function
CAG Closed Access Group
CU Central Unit
DU Distributed Unit
GID Group ID
GIN GID for Network selection
HRGN Human Readable Group Name
HRNN Human Readable Network Name
IANA Internet Assigned Numbers Authority
PEN Private Enterprise Number
PLMN Public Land Mobile Network
PNI-NPN Public Network Integrated NPN
PRN PRivate Network
NG-RANNext Generation Radio Access Network
NPN Non-Public Network
SIB System Information Block
SNPN Standalone NPN
SP Service/Subscription Provider
TAC Tracking Area Code
UPF User Plane Function
UE User Equipment

### REFERENCES

1. 3GPP TR 23.700-07 v1.2.0: Study on enhanced support of non-public networks
2. 3GPP TS 38.331 v16.3.1: NR; Radio Resource Control (RRC); Protocol specification
3. 3GPP TS 23.501 v16.7.0: System architecture for the 5G System (5GS)
4. 3GPP TS 38.300 v16.4.0: NR; NR and NG-RAN Overall description; Stage-2
5. 3GPP TS 38.401 v16.4.0: NG-RAN; Architecture description
6. 3GPP TR 23.700-07 v2.0.0: Study on enhanced support of non-public networks

1-48. (canceled)

49. A method, performed by a radio network node, of handling communication in a wireless communications network, wherein the radio network node is preconfigured with group identities and/or type parameters, the method comprising:
transmitting system information with a type parameter associated with a group identity (GID) wherein the type parameter indicates a type of service offered by one or more networks identified by the GID.

50. The method according to claim 49, wherein the type parameter is represented by one of a separate service type indication in GID information, and an indicator bitmap in which each of the bits represents a different service provided by the network.

51. The method according to claim 49, wherein the type parameter is represented by one of a list or sequence of Boolean values, in which each Boolean value represents a different service, and a service index which indicates one or more supported services from a pre-defined list of services.

52. The method according to claim 49, wherein the type parameter is represented by one of an integer or index value which points to a specific service or service combination from a list of pre-defined services, and a service type indication encoded into the GID or a GID value.

53. The method according to claim 49, wherein the type parameter is represented by a sequence of bits that corresponds to a codeword from a codebook of services or service combinations.

54. A method, performed by a user equipment (UE), of handling communication in a wireless communications network, the method comprising:
receiving system information with a type parameter associated with a group identity (GID) wherein the type parameter indicates a type of service offered by one or more networks identified by the GID.

55. The method according to claim 54, wherein the type parameter is represented by one of a separate service type indication in GID Information, and an indicator bitmap in which each bit of the bits represents a different service.

56. The method according to claim 54, wherein the type parameter is represented by one of a list or sequence of Boolean values, in which each Boolean value represents a different service, and a service index which indicates the supported service from a pre-defined list of services.

57. The method according to claim 54, wherein the type parameter is represented by one of an integer or index value which points to a specific service or service combination from a list of predefined services, and a service type indication encoded into the GID or a GID value.

58. The method according to claim 54, wherein the type parameter is represented by a sequence of bits that corresponds to a codeword from a codebook of services or service combinations or is implicitly provided by a specific encoding of the GID.

59. A radio network node for handling communication in a wireless communications network, wherein the radio network node is preconfigured with group identities or type parameters, wherein the radio network node is configured to:
transmit system information with a group identity (GID) and/or a type parameter associated with the GID, wherein the type parameter indicates a type of service offered by one or more networks identified by the GID.

60. The radio network node according to claim 59, wherein the type parameter is represented by one of a separate service type indication in GID information, and an indicator bitmap in which each of the bits represents a different service provided by the network.

61. The radio network node according to claim 59, wherein the type parameter is represented by one of a list or sequence of Boolean values, in which each Boolean value represents a different service, and a service index which indicates the supported services from a pre-defined list of services.

62. The radio network node according to claim 59, wherein the type parameter is represented by one of an integer or index value which points to a specific service or service combination from a list of predefined services, and a service type indication encoded into the GID or a GID value.

63. The radio network node according to claim 59, wherein the type parameter is represented by one of a sequence of bits that corresponds to a codeword from a codebook of services or service combinations.

64. A user equipment (UE) configured to handle communication in a wireless communications network, wherein the UE is configured to:
receive system information with a type parameter associated with a group identity (GID) wherein the type parameter indicates a type of service offered by one or more networks identified by the GID.

65. The UE according to claim 64, wherein the type parameter is represented by one of a separate service type indication in GID Information, and an indicator bitmap in which each bit of the bits represents a different service.

66. The UE according to claim 64, wherein the type parameter is represented by one of a list or sequence of Boolean values, in which each Boolean value represents a different service, and a service index which indicates the supported service from a pre-defined list of services.

67. The UE according to claim 64, wherein the type parameter is represented by one of an integer or index value which points to a specific service or service combination from a list of predefined services, and a service type indication encoded into the GID or a GID value.

68. The UE according to claim 64, wherein the type parameter is represented by a sequence of bits that corresponds to a codeword from a codebook of services or service combinations.
